(19) United States
(12) Patent Application Publication
(10) Pub. No.: US 2016/0167524 A1
(43) Pub. Date: Jun. 16, 2016

(54) VEHICLE CHARGING CONNECTORS

(71) Applicant: SYLVAN ASCENT, INC., Taos, NM (US)

(72) Inventor: Roger Bedell, Granada (ES)

(21) Appl. No.: 14/908,694

(22) PCT Filed: Jun. 24, 2014
(86) PCT No.: PCT/IB2014/001166

§ 371 Date: Jan. 29, 2016

(30) Foreign Application Priority Data
Jun. 25, 2013 (GB) 1311246.1

(51) Int. Cl. B60L 5/42; B60L 11/18

(52) U.S. Cl. CPC B60L 5/42; B60L 11/1816

(57) ABSTRACT

A vehicle charging arrangement includes a first vehicle charging connector and a second vehicle charging connector, one of the first and second vehicle charging connectors being mountable to a vehicle and the other of the first and second vehicle charging connectors being mountable to a charging gantry, the first vehicle charging connector comprising a first elongate conductor and a second elongate conductor, each of the first and second elongate conductors having a contact area with a proximal end close to the other conductor and a distal end further from the other conductor, the first and second elongate conductors being disposed parallel to each other and spaced from each other in a direction parallel with longitudinal axes of the conductors.

The present invention relates to vehicle charging connectors.

### BACKGROUND TO THE INVENTION

Electric vehicles, and in particular electric buses, are known. Electric buses offer the potential of urban public transport which is quieter and less polluting than buses powered by diesel engines, improving the air quality and level of noise in city centres. However, various practical problems have prevented widespread adoption of electric vehicle technology.

Some electric vehicles, such as trams, receive power directly from an electrical grid, for example by overhead lines. However, installing tram systems requires a great deal of initial investment, and once installed the route of a tram cannot easily be altered.

Electric buses avoid these problems by storing power in batteries carried on the bus. These batteries must be regularly charged.

One method of charging batteries in an electric bus involves the use of an overhead charging gantry, having conductors which deliver power through receiving conductors mounted to the roof of the bus. One such arrangement is disclosed in GB2475703. In this arrangement, two movable pantographs are provided on the roof of the bus, one behind the other. The pantographs can be moved upwards from the bus to meet charging conductors on a charging gantry, to charge the batteries of the bus.

When charging a vehicle, it is known to provide a “pilot” connection for allowing communication between the charger and the vehicle being charged. The pilot connection is used to test, among other things, continuity of the charging conductors before charging begins.

Although the above-described charging arrangement is designed to allow for a certain amount of tolerance in the position of the vehicle, it is possible for the vehicle to be parked at the very edge of its tolerance. In this state, the charging conductors on the charger would be electrically connected to the receiving conductors on the vehicle, but the connection may not be sound enough to effect safe charging at high current. There may be only a small area of contact between a charging conductor and its respective charge receiving member. However, this will not be apparent when performing a low-current test using a pilot connector. If charging begins when the connection is poor, there is a risk of overheating, damage to equipment, and possibly fire.

A further problem with the charging arrangement of GB2475703 is that it relies on moving parts to engage and disengage the vehicle from the charging station. If the pantographs on the roof of the bus cannot be moved for some reason, for example, due to failure of a power supply, motor, or control electronics, then the bus cannot be moved out of the charging station without causing damage to components.

It is an object of the invention to reduce or substantially obviate the above-mentioned problems.

### STATEMENT OF INVENTION

A vehicle charging arrangement comprising first and second connectors, one connector being mountable to a vehicle and the other connector being mountable to a charging gantry,
the first connector comprising first and second elongate conductors, each of the first and second elongate conductors having a contact with a proximal end close to the other conductor and a distal end further from the other conductor, the first and second elongate conductors being longitudinally spaced and disposed parallel or in-line with each other,
the contact of the second elongate conductor having a longitudinal extent which is shorter than a longitudinal extent of the contact of the first elongate conductor, and
the second connector comprising third and fourth elongate conductors, the third and fourth elongate conductors having longitudinal axes running parallel with each other, and the third and fourth elongate conductors being spaced from each other in a direction perpendicular to their longitudinal axes,
the spacing between the third and fourth elongate conductors being greater than the distance between the distal end of the contact of the second elongate conductor and the proximal end of the contact of the first elongate conductor, and being shorter than the distance between the proximal end of the contact of the second elongate conductor and the distal end of the contact of the first elongate conductor.

The spacing between the third and fourth elongate conductors may be greater than the distance between the distal end of the contact of the second conductor and the proximal end of the contact of the first conductor by a margin of at least 2.5 cm, preferably at least 5cm. Likewise, the spacing between the third and fourth elongate conductors may be shorter than the distance between the proximal end of the contact of the second elongate conductor and the distal end of the contact of the first elongate conductor by a margin of at least 2.5 cm, preferably 5 cm.

In use, the first elongate conductor of the first connector may contact the third elongate conductor of the second connector, and the second elongate conductor of the first connector may contact the fourth elongate conductor of the second connector.

The position and shorter extent of the second elongate conductor ensures that a connection will only be made by the second elongate conductor when a strong and stable connection is made by the first elongate conductor. If the first elongate conductor is positioned such that it is only in contact with the third elongate conductor at its very edge, then the second elongate conductor will not contact the fourth elongate conductor at all. An electrical connection can only be made between the second and fourth elongate conductors when the first vehicle charging connector is positioned with respect to the second vehicle charging connector such that the first elongate conductor is in contact with the third elongate conductor at a point inward of either end of the first elongate conductor. In this position, a maximum contact area will be realised, ensuring maximum conductivity. This position, inward of the ends, also ensures a degree of tolerance to any movement of the connector during the charging process.

The first elongate conductor may be adapted to provide a high power connection with the third elongate conductor, and the second elongate conductor may be adapted to provide a low power connection with the fourth elongate conductor. For example, the first and third elongate conductors may provide a connection for power transfer to charge batteries, whilst the second and fourth elongate conductors may provide an earth or pilot connection.

The first connector may be mountable to a vehicle and the second connector may be mountable to a charging gantry. Alternatively the first connector may be mountable to a charging gantry and the second connector may be mountable to a vehicle. Either way, the elongate conductors of the first connector are preferably substantially perpendicular to a longitudinal axis of the vehicle, and the conductors of the second connector are preferably substantially parallel to the longitudinal axis of the vehicle, when the charging arrangement is in use and the vehicle is receiving a charge.

In this way, the charging arrangement provides a reasonable degree of forward-backward and sideways tolerance, so that a driver can park a vehicle under a charging gantry and initiate charging quickly. When the second and fourth elongate conductors (possibly a pilot connection) are connected, the first elongate conductor is guaranteed to be mated with the third elongate conductor inward of its edge, so that a good stable connection is formed.

The charging gantry may be an overhead charging gantry and one of the connectors may be mounted to a vehicle roof.

Most preferably the first connector is mounted to a vehicle roof and the second connector is mounted to a charging gantry. This arrangement is preferable, since the first connector can be readily embodied in a lightweight form, to increase the operating efficiency of the vehicle.

The first vehicle connector may further comprise fifth and sixth elongate conductors,
each of the fifth and sixth elongate conductors having a contact with a proximal end close to the other of the fifth and sixth conductors and a distal end further from the other of the fifth and sixth conductors,
the contact of the sixth elongate conductor having a longitudinal extent which is shorter than a longitudinal extent of the contact area of the fifth elongate conductor,
the fifth and sixth elongate conductors running parallel with the first and second elongate conductors, and
the second connector further comprising seventh and eighth elongate conductors, the seventh and eighth elongate conductors having longitudinal axes running parallel with each other,
the seventh and eighth elongate conductors being spaced from each other in a direction perpendicular to the longitudinal axes of the seventh and eighth elongate conductors,
the spacing between the seventh and eighth elongate conductors being greater than the distance between the distal end of the contact of the sixth conductor and the proximal end of the contact of the fifth conductor, and being shorter than the distance between the proximal end of the contact of the sixth elongate conductor and the distal end of the contact of the fifth elongate conductor.

In other words, the arrangement of first, second, third and fourth elongate conductors may be repeated to make a total of four elongate conductors on each of two connectors. The arrangement may be repeated with the duplicate arrangements one behind the other. The appropriate arrangement in a given scenario will depend on the dimensions of the vehicle and space available on the roof, any restrictions on the charging gantry in terms of height and size, and so on.

The first and third elongate conductors may be used to provide a positive charging connection; the second and fourth elongate conductors may be used to provide a pilot connection; the fifth and seventh elongate conductors may be used to provide a negative charging connection; and the sixth and eighth elongate conductors may be used to provide a ground connection.

When continuity is successfully detected between the pilot and ground connections, good positive and negative charging connections can be guaranteed.

The first and second elongate conductors may be disposed along the same line as each other. Where provided, the fifth and sixth elongate conductors may also be disposed along the same line as each other. An insulator may be provided between the first and second elongate conductors, and an insulator may be provided between the fifth and sixth elongate conductors. In this way, the first and second elongate conductors with an insulator may form a continuous bar, and the fifth and sixth conductors with an insulator may for another continuous bar. However, it is also envisaged that, as an alternative, an air gap may be provided between the first and second conductors, and/or between the fifth and sixth conductors.

Either the vehicle-mounted connector or the gantry-mounted connector may be movable, whichever of the first and second connectors is the vehicle-mounted connector. The other connector may be mounted to the vehicle or charging gantry in a fixed position. In use, whichever connector is movable may be moved to meet the connector which is fixed.

Most preferably, both of the first and second connectors are movable and, in use, move towards each other to meet each other. This has the advantage that, if either of the two moving mechanisms should fail for any reason, then the vehicle will not be trapped in the charging gantry, since it can come free by moving whichever moving mechanism is not broken or faulty.

At least one movably mountable connector may be movable substantially in an arc, on a pivoting arm, between a retracted position and an extended position.

The pivoting connector in the extended position may be biased towards the extended position, but pivotable towards the retracted position on application of a force to the connector. In this way, a vehicle can escape from a charging gantry even when the moving mechanism of the movable connector has failed, and the other connector is mounted in a fixed position or has also failed. In this situation, where the pivoting connector is fitted to the vehicle, the vehicle may be driven in a direction with the point where the pivoting arm is mounted to the vehicle being forward-most, and with the elongate conductors trailing behind. If the pivoting connector is part of the charging gantry, then the vehicle may be driven out of the gantry in a direction with the elongate conductors forward-most, and with the pivoting arm trailing behind.

The contact of the second elongate conductor and, where provided, the sixth elongate conductor, may be vertically offset from the contact of the first and fifth elongate conductors respectively.

The fourth and, where provided, the eighth elongate conductor may be biased towards a rest position, and may be movable out of the rest position in a direction perpendicular to the longitudinal axis of the fourth elongate conductor and also perpendicular to the spacing between the third and fourth elongate conductors.

A biased and movable fourth (and/or eighth) conductor ensures that the pilot and ground connections are made first, before the high power charging connections. This feature also ensures that a good connection can be made where the first and second conductors do not form a completely straight line, and/or when the fifth and sixth conductors do not form a completely straight line, possibly because some of the conductors have become damaged. Furthermore, the biased and movable conductor provides for a good connection with the charging gantry when the vehicle is parked on a sideways slope.

A contact of the fourth elongate conductor may be shorter than a contact of the third elongate conductor, and the contacts of the third and fourth elongate conductors may be disposed side-by-side, both ends of the contact of the fourth elongate conductor being located inwardly of the ends of the contact of the third elongate conductor.

The contacts of the third and fourth elongate conductors may have elongate extents substantially parallel with the third and fourth conductors themselves.

In the same way that the shorter contact of the second conductor ensures a good connection of the first and third conductors at the sideways extreme of the parking tolerance of the charging arrangement, a shorter contact of the fourth conductor ensures a good connection of the first and third conductors at the lengthways extreme of the parking tolerance of the charging arrangement.

Where an eighth elongate conductor is provided, a contact of the eighth elongate conductor may likewise be shorter than a contact of the seventh elongate conductor.

The fourth and, where provided, eighth elongate conductor may have a width perpendicular to its longitudinal axis and parallel with the spacing between the third and fourth elongate conductors which is smaller than a corresponding width of the third and, where provided, seventh elongate conductor.

The third elongate conductor may be separated from the seventh elongate conductor by a first insulator, and the fourth elongate conductor may be separated from the eighth elongate conductor by a second insulator. In this way, the second connector may comprise of a pair of parallel bars, one bar including the third elongate conductor, the first insulator and the seventh elongate conductor, and the other bar including the fourth elongate conductor, the second insulator and the eighth elongate conductor.

The second insulator may have a length parallel with the third, fourth, seventh and eighth elongate conductors which is longer than a corresponding length of the first insulator, thus providing for shorter fourth and eighth conductors with their ends inward of the third and seventh conductors as described above.

An outer surface of at least one of the first and second insulators may be set inwardly of outer surfaces of the third, fourth, seventh and eighth elongate conductors which mount the contacts of the respective conductors. In this way, a contact surface of the second vehicle charging connector may have an inset insulating portion.

According to a second aspect of the present invention, there is provided a vehicle charging connector comprising a first elongate conductor and a second elongate conductor, each of the first and second elongate conductors having a contact with a proximal end close to the other conductor and a distal end further from the other conductor, the first and second elongate conductors being longitudinally spaced and disposed parallel or in-line with each other, the contact of the second elongate conductor having a longitudinal extent which is shorter than a longitudinal extent of the contact of the first elongate conductor.

Preferable and/or optional features of the second aspect of the invention are set out in appended claims 30 to 47.

According to a third aspect of the invention, there is provided a vehicle charging connector comprising first and second elongate conductors, the first and second elongate conductors having longitudinal axes running parallel with each other, and the first and second elongate conductors being spaced from each other in a direction perpendicular to the longitudinal axes of the first and second elongate conductors, a contact of the second elongate conductor being shorter than a contact of the first elongate conductor, and the first and second elongate conductors being disposed side-by-side, with both ends of the contact of the second elongate conductor located inwardly of the ends of the contact of the first elongate conductor.

Preferable and/or optional features of the third aspect of the invention are set out in appended claims 49 to 64.

According to a fourth aspect of the invention, there is provided a vehicle charging connector comprising first and second elongate conductors, the first and second elongate conductors having longitudinal axes running parallel with each other, and the first and second elongate conductors being spaced from each other in a direction perpendicular to their longitudinal axes, the second elongate conductor being biased into a rest position and being movable out of the rest position in a direction perpendicular to the longitudinal axis of the second elongate conductor and also perpendicular to the spacing between the first and second elongate conductors.

Preferable and/or optional features of the fourth aspect of the invention are set out in appended claims 66 to 80.

### DESCRIPTION OF THE DRAWINGS

For a better understanding of the present invention, and to show more clearly how it may be carried into effect, reference will now be made, by way of example, to the accompanying drawings. in which:

FIG. 1 shows a perspective view of a vehicle charging arrangement in use, charging a bus;

FIG. 2 shows a plan view from above of the vehicle charging arrangement of FIG. 1;

FIG. 3 shows a perspective view from in front of the vehicle charging arrangement of FIG. 1, with the vehicle disengaged from the charging gantry; and

FIG. 4 shows a schematic plan view from above of charging conductors, forming part of the charging arrangement of FIG. 1.

### DESCRIPTION OF PREFERRED EMBODIMENTS

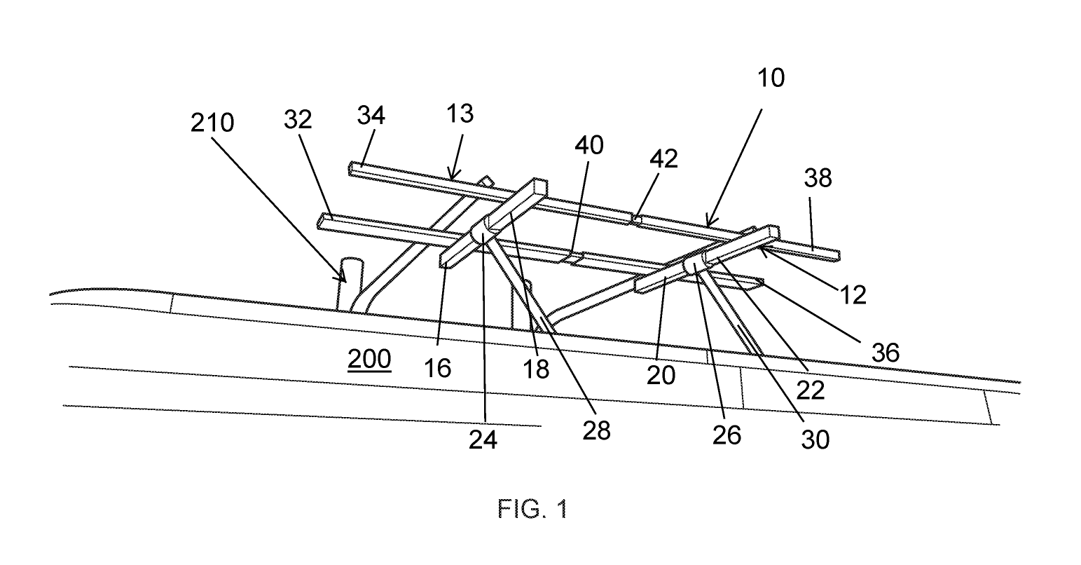

Referring firstly to FIG. 1, a vehicle charging arrangement is generally indicated at 10. The vehicle charging arrangement includes a first connector 12, and a second connector 13. The first and second connectors 12, 13 include four elongate conductors each, that is, eight conductors in all. In this embodiment, the first connector 12 is mounted to the roof of a bus 200, and the second connector 13 is provided on an overhead charging gantry 210.

The first connector 12 includes first, second, fifth and sixth elongate conductors 16, 18, 20, 22. The first and second elongate conductors are disposed in the same line as each other. each extending from opposite sides of a insulated mount 24. Likewise, the fifth and sixth elongate conductors 20, 22 are disposed in the same line as each other, extending from opposite sides of another insulated mount 26.

The first and second elongate conductors 16, 18, together with their corresponding mount 24, form a substantially horizontal bar above the roof of the bus, and are pivotally mounted to the roof of the bus via a movable arm 28. The fifth and sixth elongate conductors 20, 22 and mount 26 are likewise mounted to the bus on movable arm 30.

Movable arms 28 and 30 can be operated to move first, second, fifth and sixth elongate conductors 16, 18, 20, 22 between an extended position, as shown in FIG. 1, and a retracted position in which the pivotal arms 28, 30 and the elongate conductors 16, 18, 20, 22 are all disposed in a substantially horizontal plane just above the roof of the bus 200. The arms 28, 30, may be moved for example by electric motors. However, when the arms 28, 30 are in the extended position, they can be pressed downwardly towards the retracted position on application of a force to the elongate conductors 16, 18, 20, 22 from above. The arms 28, 30 are biased into the extended position and will therefore spring back to the extended position when any force is removed.

When the arms 28, 30 are in the retracted position, they may be locked against the roof of the bus 200, preventing any movement by applying force directly to the conductors 16, 18, 20, 22. The arms 28, 30 can only be moved from the retracted position to the extended position, and can only be locked into the retracted position, by operating the electric motors or other movement means.

The second connector 13 comprises third, fourth, seventh and eighth elongate conductors 32, 34, 36, 38. As shown in the Figure, the first elongate conductor 16 connects with the third elongate conductor 32, the second elongate conductor 18 connects with the fourth elongate conductor 34, the fifth elongate conductor 20 connects with the seventh elongate conductor 35, and the sixth elongate conductor 22 connects with the eighth elongate conductor 38.

The first and third 16, 32 and the fifth and seventh 20, 26 elongate conductors provide high-power charging connections. The second and fourth 18, 34 and sixth and eighth 22, 38 elongate conductors provide low-power pilot and earth connections. As is clear from the Figure, the fourth and eighth elongate conductors 34, 38 are substantially thinner than the third and seventh elongate conductors 32, 36.

A first insulator 40 is provided between the third and seventh elongate conductors 32, 36, and a second insulator 42 is provided between the fourth and eighth elongate conductors 34, 38. The third elongate conductor 32, the first insulator 40 and the seventh elongate conductor 36 form a bar and the fourth elongate conductor 34, the second insulator 42 and the eighth elongate conductor 38 form another bar, the two bars running parallel to each other, and spaced by around 50cm from each other.

The first and second insulators 40, 42 are thinner than the conductors 32, 36, 34, 38 to which they are respectively connected. In this way. the insulators form waisted sections of the bars. In particular, a contact surface of the second vehicle connector 12 has inset insulating sections between the conducting parts. The contact surface faces the bus 200 in the Figure.

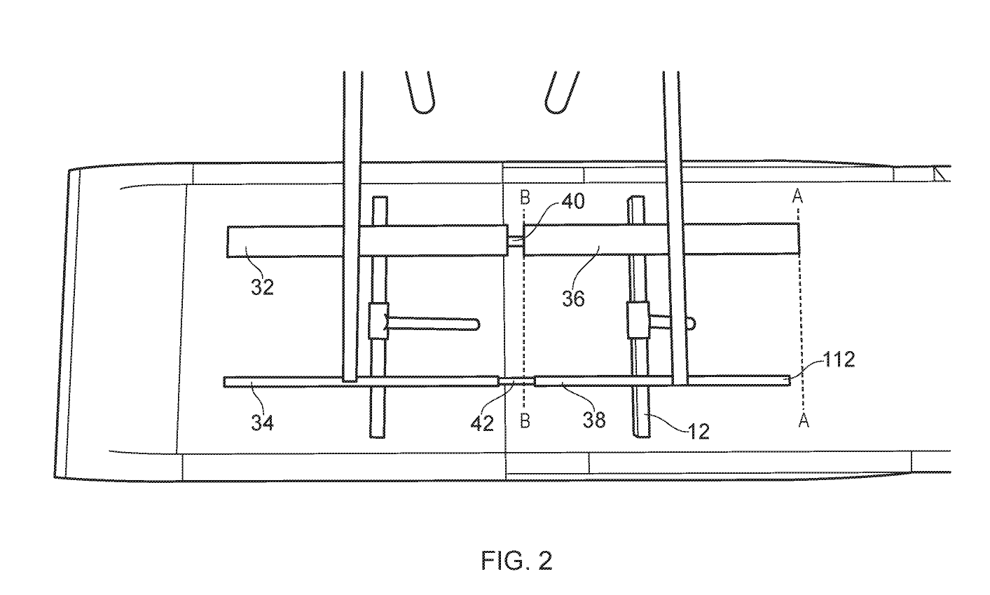

Referring now to FIG. 2, the first connector 12 and second connector 13 are shown from above. In this Figure, the relative lengths and widths of the third, fourth, seventh and eighth elongate conductors 32, 34. 36, 38, and the first and second insulators 40, 42, are clearly visible. In particular, the eighth elongate conductor 38 has both ends inward of the ends of the seventh elongate conductor 36, as shown by lines AA and BB. The second insulator 42 is longer than the first insulator 40.

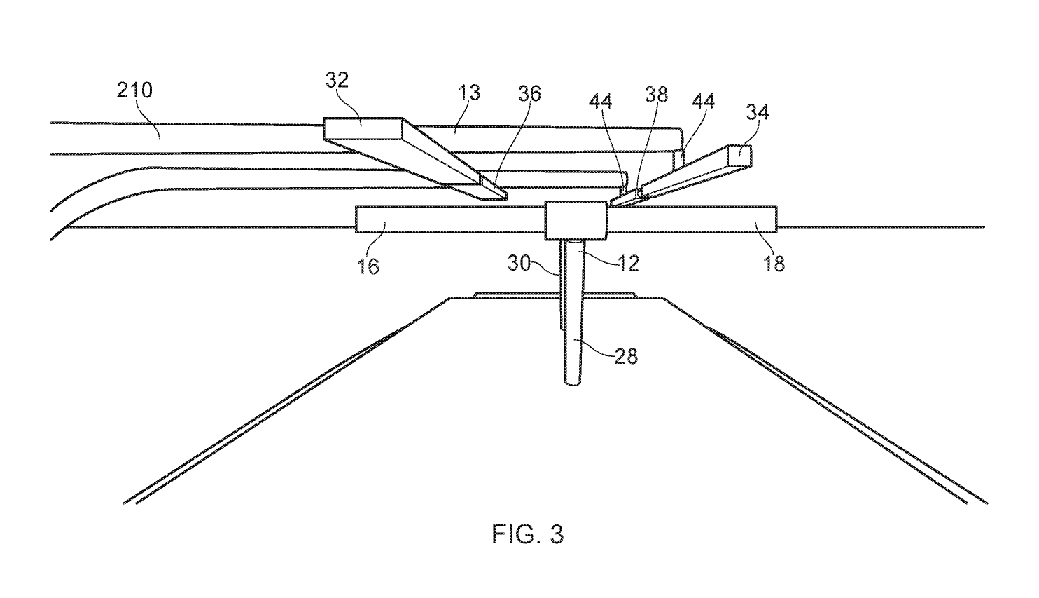

Referring now to FIG. 3, the pivoting arms 28, 30 of the first connector 12 are shown in a partially extended position. The biasing arrangement of the second charging conductor 13 is also illustrated in this Figure. The fourth and eighth elongate conductors 34, 38 are mounted to the charging gantry 210 via springs, and are suspended on the springs a few centimetres below the level of the third and seventh elongate conductors 32, 36. When the first connector 12 is extended to meet the second connector 13, the second and sixth elongate conductors 18, 22 will push upwardly on the fourth and eighth elongate conductors 34, 38. As a result, the fourth and eighth elongate conductors 34, 38 will move against the springs 44. In this way, the vertical offset between the third and seventh elongate conductors 32, 36 and the fourth and eighth elongate conductors 34, 38 is automatically adjusted when the vehicle is engaged in the charging station. If the vehicle is parked on a flat surface and the conductors are undamaged then the fourth and eighth elongate conductors 34, 38 will be lifted to the same height as the third and seventh elongate conductors 32, 36 when charging is in progress.

The force required to move the fourth and eighth elongate conductors 34, 38 against the springs 44 is around 10 to 15 Newtons. The pivoting arms 28, 30 may push the second and sixth elongate conductors 18, (22) with a force of around 80 Newtons. Therefore, when charging, the first and second connectors 12, 13 will push against each other with a force of around 65 Newtons, which is sufficient to provide a good electrical contact.

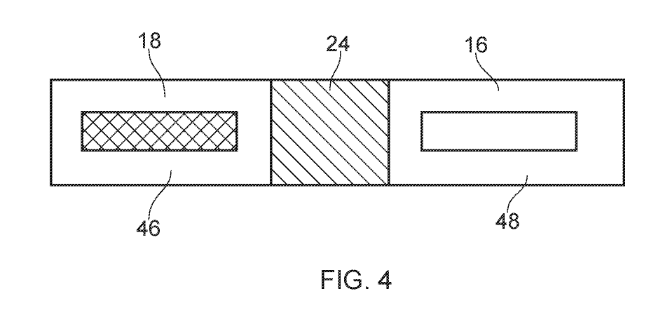

The arrangement of the first and second elongate conductors 16, 18 is best seen in FIG. 4. The first and second elongate conductors 16, 18 extend from either side of a central insulating mount 24. The overall extent of the first and second conductors 16, 18 from the mount 24 is similar. However, the actual contact area 46 which can form an electrical connection with the second charging connector 13 is substantially reduced on the second elongate conductor 18 relative to the first elongate conductor 16. The contact area of the first elongate conductor extends across substantially the entire length of the conductor 16. The contact area 46 of the second elongate conductor 18 has an overall shorter length than the contact area of the first elongate conductor 16.

The contact area 46 of the second elongate conductor 18, together with the spacing between the third and fourth conductors (32, 34) defines a working area 48 on the first elongate conductor 16. The working area 48 is inward of the ends of the first elongate conductor 16, ensuring a good stable connection to the first elongate conductor 16.

It will be appreciated that the arrangement of contact areas can be embodied in a number of different ways. For example, the contact area 46 of the second elongate conductor 18 may be formed as a raised area on a surface of the conductor, or as a conducting section surrounded by insulating material. Alternatively, the central mount 24 may be extended and the second elongate conductor 18 shortened, with the contact area 46 extending along the entire length of the second elongate conductor 18.

The embodiments described above are provided by way of example only, and various changes and modifications will be apparent to persons skilled in the art without departing from the scope of the present invention as defined by the appended claims.

1-83. (canceled)

84. A vehicle charging arrangement comprising:
a first connector including:
a first elongate conductor having a first electrical contact area; and
a second elongate conductor longitudinally spaced from the first elongate conductor with respect to a longitudinal axis of the first elongate conductor and a longitudinal axis of the second elongate conductor, the second elongate conductor having a second electrical contact area, the first electrical contact area having a proximal end proximate the second elongate conductor and a distal end distal to the second elongate conductor, the second electrical contact area having a proximal end proximate the first elongate conductor and a distal end distal to the first elongate conductor, a longitudinal extent of the second electrical contact area is less than a longitudinal extent of the first electrical contact area, the first elongate conductor disposed one of parallel to and in-line with the second elongate conductor; and
a second connector configured to form an electrical connection with each of the first electrical contact area and the second electrical contact area, the second connector including:
a third elongate conductor having a third electric contact area configured to form an electrical connection with the first connector; and
a fourth elongate conductor disposed parallel to the third elongate conductor and spaced from the third elongate conductor in a direction perpendicular to a longitudinal axis of the third elongate conductor and a longitudinal axis of the fourth elongate conductor, the fourth elongate conductor having a fourth electric contact area configured to form an electrical connection with the first connector;
a distance between the third electrical contact area and the fourth electrical contact area is greater than a distance between the distal end of the second electrical contact area and the proximal end of the first electrical contact area and less than a distance between the proximal end of the second electrical contact area and the distal end of the first electrical contact area, the first elongate conductor adapted to provide a high power connection with the third elongate conductor, and the second elongate conductor adapted to provide a low power connection with the fourth elongate conductor;
wherein the first elongate conductor and the second elongate conductor are simultaneously movable relative to the vehicle for connection to the second connector.

85. The vehicle charging arrangement of claim 84, wherein the first connector is mountable to a vehicle and the second connector is mountable to a charging gantry.

86. The vehicle charging arrangement of claim 85, wherein the first connector is mounted to the vehicle and the first elongate conductor and second elongate conductor extend substantially perpendicular to a longitudinal axis of the vehicle.

87. The vehicle charging arrangement of claim 84, wherein the first connector is mountable to a charging gantry and the second connector is mountable to a vehicle.

88. The vehicle charging arrangement of claim 84, wherein one of the first connector and the second connector is mountable to an overhead charging gantry and another one of the first connector and the second connector is mountable to a vehicle roof.

89. The vehicle charging arrangement of claim 84, wherein the first elongate conductor is disposed in-line with the second elongate conductor.

90. The vehicle charging arrangement of claim 84, wherein one of the first connector and the second connector is movably mountable to a vehicle.

91. The vehicle charging arrangement of claim 84, wherein one of the first connector and the second connector is movably mountable to a charging gantry.

92. The vehicle charging arrangement of claim 84, wherein the second electrical contact area is vertically offset from the first electrical contact area.

93. The vehicle charging arrangement of claim 84, wherein the fourth elongate conductor is biased towards a rest position, the fourth elongate conductor movable out of the rest position in a direction perpendicular to the longitudinal axis of the fourth elongate conductor and perpendicular to the spacing between the third elongate conductor and the fourth elongate conductor when a force is applied to the fourth elongate conductor.

94. The vehicle charging arrangement of claim 84, wherein a longitudinal extent of the fourth electrical contact area is less than a longitudinal extent of the third electrical contact area, and the third electrical contact area is disposed adjacent the fourth electrical contact area, and wherein ends of the fourth electrical contact area are located inwardly of ends of the third electrical contact area.

95. The vehicle charging arrangement of claim 84, wherein the fourth elongate conductor has a width perpendicular to the longitudinal axis thereof and parallel with a space between the third elongate conductor and the fourth elongate conductor, the width of the fourth elongate conductor is less than a width of the third elongate conductor.

96. The vehicle charging arrangement of claim 84, wherein the first vehicle connector further includes:
a fifth elongate conductor having a fifth electrical contact area configured for forming an electrical connection with the second connector; and
a sixth elongate conductor having a sixth electrical contact area configured for forming an electrical connection with the second connector, the fifth electrical contact area including a proximal end proximate the sixth elongate conductor and a distal end distal to the sixth elongate conductor, the sixth electrical contact area including a proximal end proximate the fifth elongate conductor and a distal end distal to the fifth elongate conductor, a longitudinal extent of the sixth electrical contact area is less than a longitudinal extent of the fifth electrical contact area, the fifth elongate conductor disposed one of parallel to and in-line with the sixth elongate conductor; and
wherein the second connector further includes:
a seventh elongate conductor having a seventh electrical contact area configured for forming an electrical connection with the first connector; and
an eighth elongate conductor disposed parallel to the seventh elongate conductor and spaced from the seventh elongate conductor in a direction perpendicular to a longitudinal axis of the seventh elongate conductor and a longitudinal axis of the eighth elongate conductor, the eighth elongate conductor having an eighth electrical contact area configured for forming an electrical connection with the first connector;
a distance between the seventh elongate conductor and the eighth elongate conductor is greater than a distance between the distal end of the sixth electrical contact area and the proximal end of the fifth electrical contact area and less than a distance between the proximal end of the sixth electrical contact area and the distal end of the first fifth contact area.

97. The vehicle charging arrangement of claim 96, wherein the fifth elongate conductor is in-line with the sixth elongate conductor.

98. The vehicle charging arrangement of claim 97, wherein the eighth elongate conductor is biased towards a rest position, the eighth elongate conductor movable out of the rest position in a direction perpendicular to the longitudinal axis of the eighth elongate conductor and perpendicular to a space between the seventh elongate conductor and eighth elongate conductor when a force is applied to the eighth elongate conductor.

99. The vehicle charging arrangement of claim 96, wherein a longitudinal extent of the eighth electrical contact area is less than a longitudinal extent of the seventh electrical contact area, and the seventh electrical contact area is disposed adjacent the eighth elongate electrical contact area, and wherein ends of the eighth electrical contact area are located inwardly of ends of the seventh electrical contact area.

100. The vehicle charging arrangement of claim 96, wherein the eighth elongate conductor has a width perpendicular to the longitudinal axis thereof and parallel with a space between the seventh elongate conductor and the eighth elongate conductor, the width of the eighth elongate conductor is less than a width of the seventh elongate conductor.

101. The vehicle charging arrangement of claim 96, wherein the third elongate conductor is separated from the seventh elongate conductor by a first insulator, and the fourth elongate conductor is separated from the eighth elongate conductor by a second insulator.

102. The vehicle charging arrangement of claim 101, wherein the second insulator has a length parallel with the third elongate conductor, the fourth elongate conductor, the seventh elongate conductor, and the eighth elongate conductor, the length of the second insulator is greater than a length of the first insulator.

103. The vehicle charging arrangement of claim 101, wherein an outer surface of at least one of the first insulator and the second insulator is inwardly set from an outer surface of the third elongate conductor, an outer surface of the fourth elongate conductor, an outer surface of the seventh elongate conductor, and an outer surface of the eighth elongate conductor, each of the outer surface of the third elongate conductor, the outer surface of the fourth elongate conductor, the outer surface of the seventh elongate conductor, and the outer surface of the eighth elongate conductor mount the contact areas of the respective conductors.
